(19) United States
(12) Patent Application Publication
(10) Pub. No.: US 2014/0170364 A1
(43) Pub. Date: Jun. 19, 2014

(54) HOMOGENEOUS AND STRETCHABLE HIGH MODULUS MATERIAL STRUCTURE

(71) Applicants: Alfred Sasko, Bratislava (SK); Stijn Himpe, Landegem (BE); Veerle Van Wassenhove, Aarsele (BE); Dirk Tytgat, Zwevegem (BE); Manuel Willequet, Vichte (BE); Steven Wostyn, Desselgem (BE)

(72) Inventors: Alfred Sasko, Bratislava (SK); Stijn Himpe, Landegem (BE); Veerle Van Wassenhove, Aarsele (BE); Dirk Tytgat, Zwevegem (BE); Manuel Willequet, Vichte (BE); Steven Wostyn, Desselgem (BE)

(73) Assignee: NV BEKAERT SA

(21) Appl. No.: 14/232,456

(22) PCT Filed: Jun. 18, 2012
(86) PCT No.: PCT/EP2012/061555

§ 371 Date: Jan. 13, 2014

(30) Foreign Application Priority Data
Jul. 14, 2011 (EP) 11173944.7

(51) Int. Cl. D03D 1/02; D03D 15/08; B32B 5/02

(52) U.S. Cl. CPC D03D 1/02; B32B 5/024; D03D 15/08
USPC 428/58; 442/184

(57) ABSTRACT

A hybrid fabric comprises in one direction high modulus elongated elements and in another direction low modulus elongated elements and further low modulus elongated elements keep the high modulus elongated elements at a uniform distance. The low modulus elongated dements have an elongation at break of more than 10% in order to allow stretching of the fabric in the other direction while maintaining the high modulus elongated elements at a uniform distance. The hybrid fabric is particularly suitable to form a two-dimensional or three-dimensional shaped structure. The hybrid fabric may be used in a carcass of a tire.

### TECHNICAL FIELD

The present invention relates to a hybrid fabric, and a method to provide such a hybrid fabric. The invention further relates to the use of the hybrid fabric in a carcass of a tire.

### BACKGROUND ART

JP-A-2010 255141 disclosed a tire cord fabric, which includes tire cords, each formed of synthetic fiber or pulp type fibers arranged as warp yarns. Wefts comprising polyethylene fibers or polypropylene fibers are alternatively interwoven into the warp yarns. Gaps with predetermined size are formed between warp yarns in groups of 5 to 20 yarns.

On one hand, the defined gaps between groups of predetermined number of tire cords function as cutting margins in order to provide joint-less bands after rubber calendaring process. On the other hand, if all the warp yarns are arranged at equal intervals with a predetermined warp density, a dispersion risk could arise during rubber calendering process, thus the variation in number of tire cords in the one joint-less band will come out. Besides, the uniformity of the intervals is lost at the same time. Even though arranged gaps of the warp yarn groups can minimize the dispersion risk and keep the number of the tire cords contained in one joint-less band sustained, it still can not prevent uniformity failures of final reinforced composite.

Such a tire cord fabric was used as reinforcement of a breaker or belt layer in a tire but not as a carcass of a tire.

### DISCLOSURE OF INVENTION

It is an object of the invention to provide an improved fabric wherein the drawback of the above stated prior art is obviated.

It is also an object of the present invention to provide a new type of a hybrid fabric.

It is still another object of the present invention to provide a new two-dimensional or three-dimensional shaped structure formed by the hybrid fabric.

According to the first aspect of the invention there is provided a hybrid fabric. The hybrid fabric comprises in one direction high modulus elongated elements and in another direction low modulus elongated elements.

The low modulus elongated elements keep the high modulus elongated elements at a uniform distance. The low modulus elongated elements having an elongation at break of more than 10%, e.g. more than 50%, e.g. more than 100%, in order to allow stretching of the fabric in the other direction while maintaining the high modulus elongated elements at a uniform distance.

The terms “high modulus elongated elements” refer to elongated elements having a modulus of elasticity E greater than 5000 MPa, e.g. higher than 10000 MPa, e.g. higher than 100000 MPa.

Preferably the high modulus elongated elements have an elongation at break of less than 10%, e.g. less than 5%.

The terms “low modulus elongated elements” refer to elongated elements having a modulus of elasticity E less than 5000 MPa, e.g. less than 4000 MPa, e.g. less than 1500 MPa.

The terms “keep at uniform distance” means that in the other direction the distance between two adjacent high modulus elongated elements is substantially equal along a low modulus elongated element, i.e. shows a uniformity tolerance which is equal to or less than 3 EPDM (=ends per decimetre) along the whole length of the low modulus elongated element.

The terms ‘the other direction’ does not necessarily mean that this direction is perpendicular to the ‘one direction’. The other direction may be perpendicular, oblique (i.e. forming an angle different from 90°) or may even be zigzag with respect to the ‘one direction’.

The hybrid fabric according to the invention makes it possible to obtain high levels of EPDM, e.g. from 14 EPDM to 200 EPDM.

In a preferable embodiment of the invention, the high-modulus elongated elements are in warp direction and the low modulus elongated elements are in weft direction.

Most preferably, the high modulus elongated elements are connected by the low modulus elongated elements by means of any form of endless weaving, circular weaving or by means of shuttle and loom.

Alternatively, the high-modulus elongated elements may be in weft direction and the low modulus elongated elements may be in warp direction. Preferably, the high modulus elongated elements are connected by the low modulus elongated elements by means of a rapier loom or an air jet loom.

According to a second aspect of the invention, the hybrid fabric of the first aspect of the invention is particularly suitable to form a two-dimensional or three-dimensional shaped structure. The two-dimensional or three-dimensional structure is axial-symmetric. The axis of symmetry may be parallel to one of the high modulus elongated elements.

The two-dimensional or three-dimensional shaped structure may comprise band weaves sewed together wherein each of the band weaves is a hybrid fabric according to the first aspect of the invention.

Preferably adjacent band weaves overlap partially with one another.

In an alternative embodiment, the three-dimensional shaped structure may have the high modulus elongated elements being connected by the low modulus elongated elements by means of circular weaving.

The hybrid fabric according to the first aspect of the invention and the two-dimensional structure or three-dimensional structure according to the second aspect of the invention may be used in a carcass of a tire.

### BRIEF DESCRIPTION OF FIGURES IN THE DRAWINGS

FIG. 1 is a cross-section of an embodiment of a hybrid fabric according to a first aspect of the invention.

FIG. 2 is an upper view of a band weave consisting of a hybrid fabric.

FIG. 3 illustrates two band weaves sewed together.

FIG. 4 is a two-dimensional structure according to the second aspect of the invention.

FIG. 5 illustrates the making of a three dimensional structure according to the second aspect of the invention.

FIG. 6 shows a three dimensional structure according to the second aspect of the invention to be used in a carcass of a tire.

### MODE(S) FOR CARRYING OUT THE INVENTION

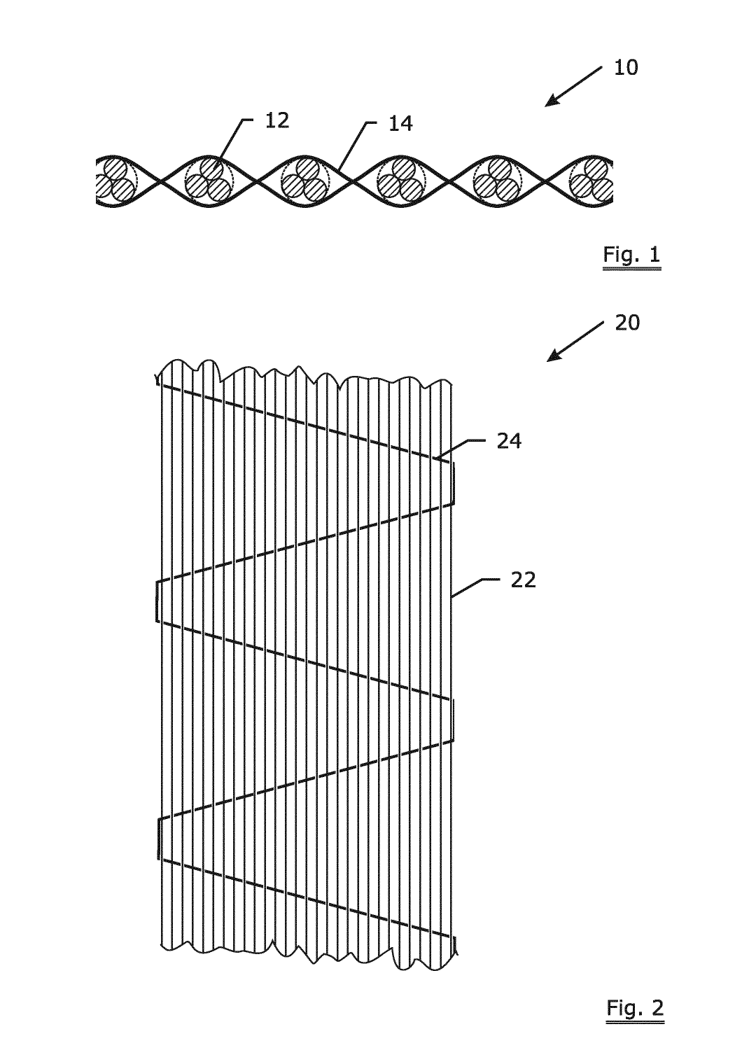

FIG. 1 shows a cross-section of a hybrid fabric 10 according to a first aspect of the present invention. The hybrid fabric 10 comprises steel cords 12 in warp direction and elastane elements 14 in weft direction.

The steel cords 12 can be 3×0.14 super tensile steel cords, but any other suitable high modulus elongated element can be used. The modulus of elasticity E of the 3×0.14 ST steel cord is 210 000 MPa. The elongation of this steel cord is 2.72%.

It is to be understood that the invention is not limited to the steel cord construction specified above, but that it may also extend to other possible constructions which can satisfy the end application of the fabric. E.g. for tire application any currently used steel cord could be used in the hybrid fabric as a high modulus elongated element. The steel cord comprises a plurality of steel filaments, ranging from 0.08 mm up to 0.5 mm, preferably from 0.08 mm to 0.30 mm; tensile strengths ranging from normal tensile (2000 MPa) up to mega tensile (4750 MPa).

Steel cord coating could be brass or ternary or quaternary alloys.

Cord constructions could be
Monofilament: crimped or pre-formed monofilament;
single layer n×1: n ranging from 2 to 6;
concentric multilayer: 1 or more core filaments, surrounded by 1 or multiple outer layers, for example 1+6, 3+9, 1+6+12, with or without spiral;
multistrand m×n cords: with m and n ranging from 2 to 7;
m+n cords: with m parallel filements, pitch infinity and n filaments with a pitch ranging from 4 mm to 30 mm, m and n ranging from 1 to 10.

Special cords like HE or HI cords and so on.

The elastane elements 14 are made from a synthetic fibre known for its exceptional elasticity. It is a polyurethane-polyurea copolymer. The modulus of elasticity E of elastane is 0.11 cN/dtex (10.46 MPa) and the elongation at break is 550%.

FIG. 2 is a band weave 20 with steel cords 22 in warp and elastane elements 24 in weft. The high modulus steel cords 22 are connected by the low modulus elastane elements 24 by means of endless weaving, band weaving, or circular weaving. A high number of ends per decimetre (EPDM) can be reached, depending upon the respective diameters of the steel cords 22 and the elastane elements 24. Values of EPDM between 14 and 200 can be reached, e.g. between 20 and 140.

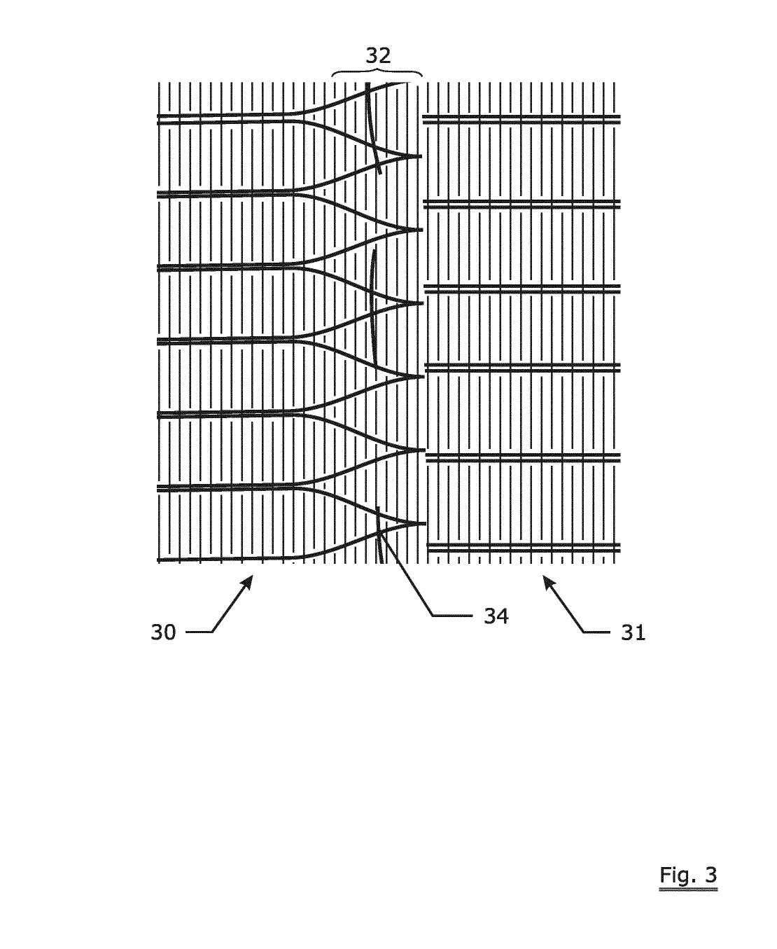

FIG. 3 illustrates two overlapping band weaves 30 and 31 sewed together. The structure shows a zone of overlapping 32. Inside this zone a sewing thread 34 keeps the band weaves 30 and 31 together.

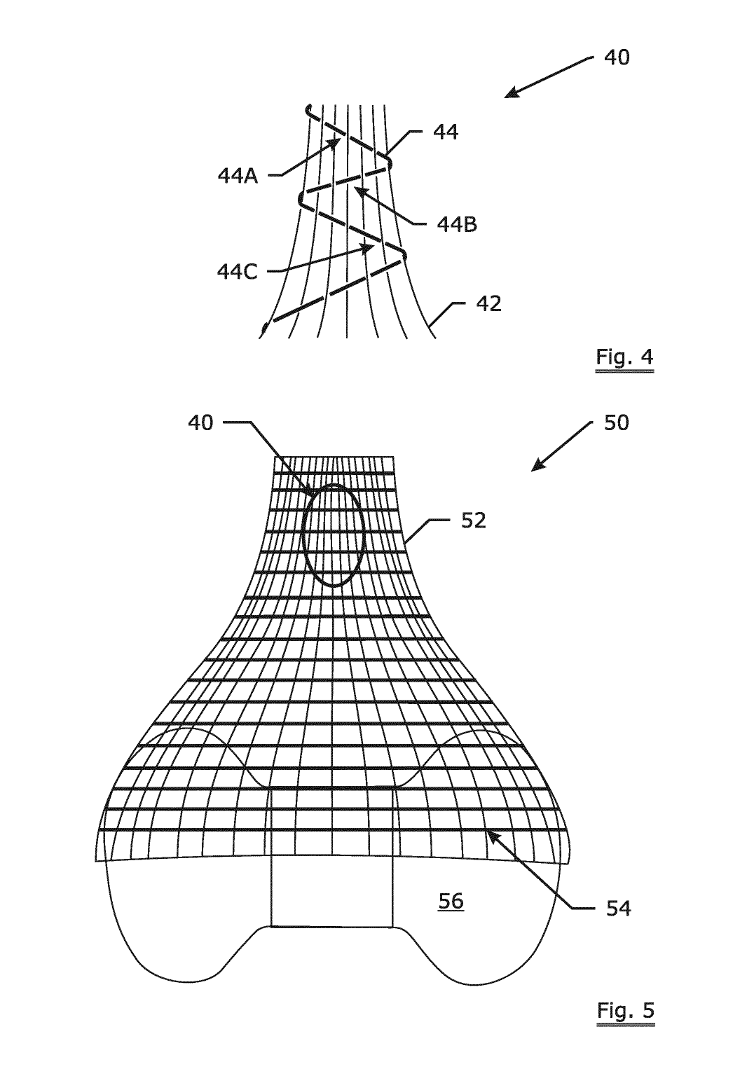

FIG. 4 shows a two-dimensional structure 40 having steel cords 42 in warp and an endless weaving of an elastane element 44 in weft. The elastane element 44 can be divided into separate consecutive elastane parts 44A, 44B and 44C. Each part 44A, 44B and 44C connects the steel cords over the whole width. Along each part 44A, 44B and/or 44C, the distance between two adjacent steel cords 42 is substantially equal, although these inter-distances are small along part 44A, greater along part 44B and even greater along part 44C.

As is clear from FIG. 4, the terms “maintaining the high modulus elongated elements at a uniform distance” do not mean that high modulus elongated element number 1 is at the same distance from neighbouring high modulus elongated element number 2 along its length.

Instead the terms “maintaining the high modulus elongated elements at a uniform distance” mean that along one low modulus elongated element, number 2 high modulus elongated element is at about the same distance from number 1 high modulus elongated element as is number 3 high modulus elongated element from number 2 high modulus elongated element.

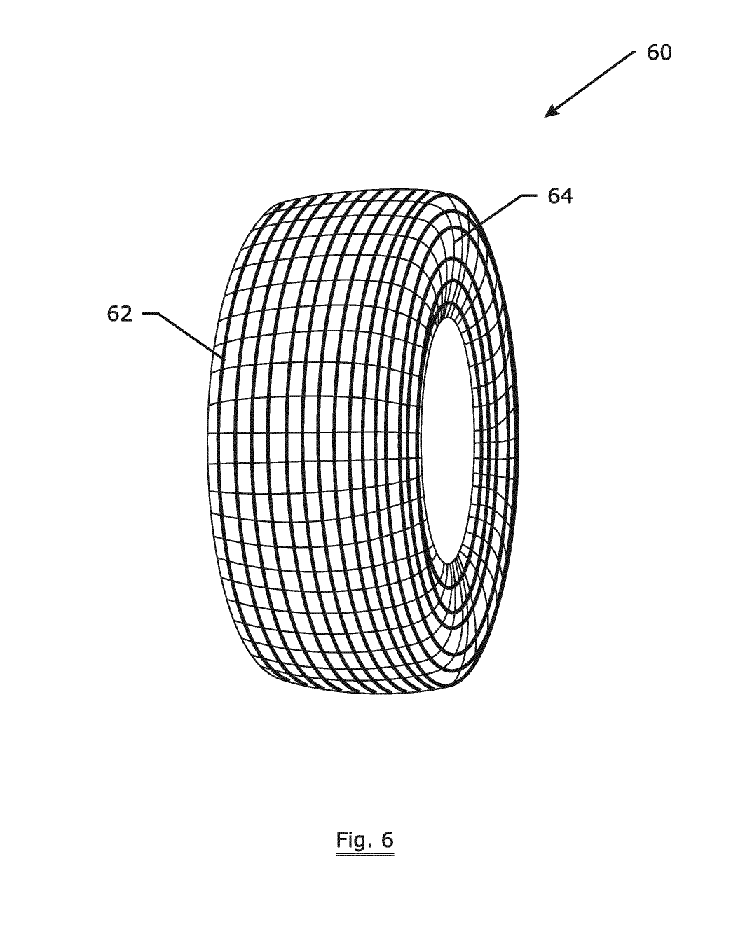

FIG. 5 illustrates the making of a three dimensional structure 50 according to the second aspect of the invention. The three-dimensional structure 50 comprises steel cords 52 in warp and elastane elements 54 in weft. Initially the three-dimensional structure 50 has a cylindrical form. One end of the cylindrical form is stretched and pulled over a plaster matrix 56. The result can be seen on FIG. 6.

FIG. 6 shows a final three-dimensional structure 60 in the form of a carcass net. Steel cords 64 are in warp and elastane elements 62 are in weft.

Such a structure can easily be handled, stretched and shaped to a carcass net shape and during the whole way of making the carcass net 60 the uniformity of distances between each adjacent steel cords 64 can be successfully kept.

It is to be understood that the invention is not limited to such a hybrid fabric wherein the steel cord as high modulus elongated element and elastane as low modulus elongated element. However, e.g. carbon fibre, glass fibre or Kevlar (Du Pont aramid fiber), Dyneema (DSM HDPE fiber or Polyethylene) or PP (polypropylene) or rayon etc. can also be used as high modulus elongated element and Nylon (polyamide fibre), PEN (polyethylenenaphthalate), or PET (polyester fibre) etc. can also be used as low modulus elongated element.

It is also to be understood that the invention is not limited to the use in a carcass of a tire, but also in many different technical field. Such as medical applications, the carcass net is useful to be pulled over legs and arms or any other three-dimensional structure. Also in construction industry, it is adapted to the reinforcement of concrete or polymer beams or pipes or hoses etc. Besides, it is also adapted to the reinforcement of blades of windmills or sailing masts or any wing-like structures, etc. Further, it is also to be understood that the invention can be used as a reinforcement of structures where a matrix (polymer or concrete or metal etc.) material will be cast or moulded or injection molded etc. around such a reinforcement two-dimensional structure or three-dimensional structure according to the second aspect of the invention.

### LIST OF REFERENCE NUMBERS

10 hybrid fabric

12 steel cord

14 elastane

20 band weave

22 steel cord

24 elastane

30, 31 overlapping band weaves

32 zone of overlapping

34 sewing thread

40 two-dimensional structure

42 steel cord

44 elastane

44A/44B/44C separate consecutive elastane parts

50 three-dimensional structure

52 steel cord

54 elastane

56 plaster matrix

60 three dimensional carcass net

62 elastane

64 steel cord

1.-11. (canceled)

12. A hybrid fabric comprising
in one direction high modulus elongated elements and in another direction low modulus elongated elements,
said low modulus elongated elements keeping the high modulus elongated elements at a uniform distance,
said low modulus elongated elements having an elongation at break of more than 10% in order to allow stretching of the fabric in said other direction while maintaining said high modulus elongated elements at a uniform distance.

13. A hybrid fabric according to claim 12, wherein the density of high modulus elongated elements varies between 14 EPDM and 200 EPDM.

14. A hybrid fabric according to claim 12, wherein the high-modulus elongated elements are in warp direction and the low modulus elongated elements are in weft direction.

15. A hybrid fabric according to claim 14, wherein the high modulus elongated elements are connected by the low modulus elongated elements by means of any form of endless weaving, shuttle and loom or circular weaving.

16. A two-dimensional shaped structure comprising a hybrid fabric according to claim 12, said two-dimensional structure being axial-symmetric, the axis of symmetry being parallel to one of the high modulus elongated elements.

17. A three-dimensional shaped structure comprising a hybrid fabric according to claim 12, said three-dimensional structure being axial-symmetric.

18. A three-dimensional shaped structure according to claim 17, wherein the axis of symmetry is parallel to one of the high modulus elongated elements.

19. A two-dimensional shaped structure according to claim 16, wherein said structure comprises band weaves sewed together and wherein each of said band weaves is said hybrid fabric.

20. A structure according to claim 19, wherein adjacent band weaves overlap partially with one another.

21. A three-dimensional shaped structure according to claim 17, wherein the high modulus elongated elements are connected by the low modulus elongated elements by means of circular weaving.

22. A method of using a hybrid fabric according to claim 12 in a carcass of a tire.

23. A three-dimensional shaped structure according to claim 17, wherein said structure comprises band weaves sewed together and wherein each of said band weaves is said hybrid fabric.

24. A structure according to claim 23, wherein adjacent band weaves overlap partially with one another.
